(19) United States
(12) Patent Application Publication
(10) Pub. No.: US 2026/0230424 A1
(43) Pub. Date: Aug. 6, 2026

(54) Prioritized Detection of BFD/S-BFD Faults for Fault Recovery and Datapath Availability

(71) Applicant: Ciena Corporation, Hanover, MD (US)

(72) Inventors: Priyanshu, Meerut (IN); Ashutosh Aggarwal, New Delhi (IN); Aditya Mittal, Gurugram (IN)

(73) Assignee: Ciena Corporation, Hanover, MD (US)

(21) Appl. No.: 19/085,262

(22) Filed: Mar. 20, 2025

(30) Foreign Application Priority Data
Feb. 5, 2025 (IN) 202541009463

(51) Int. Cl. H04L 45/28; H04L 43/0823

(52) U.S. Cl. CPC H04L 45/28; H04L 43/0823

(57) ABSTRACT

Systems and methods provide prioritizing detection of Bidirectional Forwarding Detection (BFD) or Seamless BFD (S-BFD) faults in a network having BFD or S-BFD sessions. In an embodiment, a method includes steps of specifying a prioritization attribute for at least one BFD or S-BFD session of the BFD or S-BFD sessions to designate the at least one BFD or S-BFD session as high priority relative to other concurrently configured sessions of the BFD or S-BFD sessions; monitoring the BFD or S-BFD sessions for faults; and upon detecting a fault in the at least one BFD or S-BFD session, processing the detected fault with higher precedence than faults detected in sessions not designated as high priority, thereby expediting recovery for critical traffic flows and reducing downtime.

### FIELD OF THE DISCLOSURE

The present disclosure relates generally to networking. More particularly, the present disclosure relates to systems and methods for prioritized detection of bidirectional forwarding detection (BFD)/seamless BFD (S-BFD) faults for fault recovery and datapath availability.

### BACKGROUND OF THE DISCLOSURE

Bidirectional Forwarding Detection (BFD), as specified in RFC 5880 (June 2010), the contents of which are incorporated by reference, is a lightweight protocol designed to provide sub-second fault detection in Internet Protocol (IP) and Multiprotocol Label Switching (MPLS) networks by continuously monitoring the health of a path between two endpoints. Seamless BFD (S-BFD), specified in RFC 7880 (July 2016), the contents of which are incorporated by reference, builds on BFD's foundations by streamlining session establishment and simplifying control-plane interactions, thereby enabling faster and more efficient failure detection. Together, BFD and S-BFD have become cornerstone technologies for network resiliency, rapidly detecting and notifying failures in complex, high-availability environments. These protocols are widely employed across multiple transport technologies-including link aggregation groups (LAG), MPLS, IP, segment routing (SR), and pseudowire environments-to enable near real-time detection and rapid failover in the event of link or path degradation. In particular, BFD/S-BFD provides the underlying mechanism for network administrators, software-defined networking (SDN) controllers, and path computation element protocol (PCEP) entities to validate datapath availability and continuously monitor critical network links. As emerging use cases such as cloud-based applications, 5G transport networks, and complex multi-layer architectures drive an increase in the number of concurrent sessions, the need to prioritize fault detection and recovery among multiple BFD/S-BFD sessions has become increasingly important.

### BRIEF SUMMARY OF THE DISCLOSURE

The present disclosure relates to systems and methods for prioritized detection of Bidirectional Forwarding Detection (BFD) and Seamless BFD (S-BFD) faults to improve fault recovery and datapath availability. Although BFD/S-BFD protocols are widely recognized for their sub-second fault detection capabilities, current standards do not define mechanisms to prioritize fault processing or notify peers about BFD/S-BFD faults with relative priority compared to other concurrently configured endpoints. This lack of prioritization can be problematic in use cases where certain traffic flows demand more urgent attention. For instance, prioritized detection of datapath availability (see FIG. 2), prioritization of detection/handling BFD/S-BFD faults at the peer (see FIG. 3), and prioritization of detection/handling local BFD/S-BFD faults (see FIG. 4) can be useful in maintaining strict service-level objectives. As existing standards do not address BFD/S-BFD packet, fault detection, or recovery prioritization—whether implemented in hardware or software—network operators often struggle to balance real-time fault detection with the varying importance of different network paths.

By assigning and enforcing priorities among multiple BFD/S-BFD sessions, operators can implement rapid recovery for high-priority traffic, limit or minimize downtime, and optimize overall network performance. To address this need, the present disclosure discusses techniques such as introducing prioritized BFD diagnostic codes, enabling a configuration knob for BFD prioritization, and maintaining two S-BFD reflector instances (prioritized and non-prioritized) with the same reflector discriminator to reflect packets according to prioritized S-BFD diagnostic codes. These enhancements may collectively streamline and optimize BFD/S-BFD fault notification handling and recovery, further bolstering reliability and service continuity across diverse transport environments. Embodiments are implemented to prioritize the responses to certain designated BFD/S-BFD faults. Messages are generated and sent indicating that a fault has occurred and that responding to the fault (e.g. by correcting it or adjusting to compensate for it) is a priority. In some embodiments, this messaging can be performed by a dedicated interface.

In various embodiments, the present disclosure contemplates implementation as a method with steps, via an apparatus, processing device, circuitry, or a router configured to implement the steps, and as a non-transitory computer-readable medium storing instructions that, when executed, cause circuitry to perform the steps. The steps include specifying a prioritization attribute for at least one BFD or S-BFD session of the BFD or S-BFD sessions to designate the at least one BFD or S-BFD session as high priority relative to other concurrently configured sessions of the BFD or S-BFD sessions; monitoring the BFD or S-BFD sessions for faults; and upon detecting a fault in the at least one BFD or S-BFD session, processing the detected fault with higher precedence than faults detected in sessions not designated as high priority.

The prioritization attribute is a configurable parameter in a BFD or S-BFD session template or profile that, when enabled, designates a session as high priority for expedited bootstrapping and fault handling, and when disabled, reverts to standard BFD or S-BFD processing maintaining backward compatibility. The steps can further include assigning prioritized diagnostic (diag) codes, distinct from standard diag codes, to indicate high-priority sessions and enable accelerated handling of fault notifications. The steps can further include forwarding a prioritized diag code to a remote peer, causing the remote peer to elevate handling of the associated fault relative to other non-prioritized sessions. The steps can further include maintaining two or more reflector instances for S-BFD at a tail-end node, wherein a first reflector instance handles BFD or S-BFD sessions marked with a prioritized diag code and a second reflector instance handles non-prioritized sessions.

The steps can further include enabling prioritized bootstrapping for the at least one BFD or S-BFD session, causing any path validation or initial session setup for the at least one BFD or S-BFD session to be performed with higher urgency relative to non-prioritized sessions. Local fault processing on a node prioritizes detection and notification of high-priority sessions over a plurality of concurrent non-prioritized sessions, thereby reducing queuing delays when multiple faults occur simultaneously. Upon detecting a unidirectional link failure for a high-priority session, a fault notification is escalated to trigger a faster switchover to a backup path for latency-sensitive or mission-critical traffic. The steps can further include generating a fast reroute trigger when a prioritized diag code indicates a link or path failure, thereby reducing downtime for critical data flows. The steps can further include transmitting control packets with a prioritized diag code to network devices, each device performing a higher-precedence state transition for the affected session to maintain stringent service-level objectives for critical traffic.

### BRIEF DESCRIPTION OF THE DRAWINGS

The present disclosure is detailed through various drawings, where like components or steps are indicated by identical reference numbers for clarity and consistency.

FIG. 1 illustrates a network split into two distinct transport “domains,” a domain 12 using MPLS-transport protocol (MPLS-TP) and another domain using an intermediate system-intermediate system (IS-IS)-based Segment Routing solution, for a reference topology used for various descriptions herein.

FIG. 2 illustrates the IS-IS SR domain from the network of FIG. 1 for illustrating a need for prioritizing BFD bootstrapping to allow faster data-forwarding.

FIG. 3 illustrates the MPLS-TP domain from the network of FIG. 1 for illustrating a need for prioritizing BFD fault processing.

FIG. 4 illustrates the network of FIG. 1 for illustrating a need for prioritizing BFD fault processing.

FIG. 5 illustrates the IS-IS SR domain from the network of FIG. 1, as in FIG. 2, for illustrating the proposed solution for prioritizing BFD bootstrapping to allow faster data-forwarding.

FIG. 6 illustrates the MPLS-TP domain from the network of FIG. 1, as in FIG. 3, for illustrating the proposed solution for prioritizing BFD fault processing.

FIG. 7 illustrates the network, as in FIG. 4, for illustrating the proposed solution for prioritizing BFD fault processing.

FIG. 8 illustrates a block diagram of a router R1-R6, depicted in a simplified functional format.

FIG. 9 illustrates a block diagram of an example processing device.

FIG. 10 illustrates a flowchart of a process for performing Bidirectional Forwarding Detection (BFD) or Seamless BFD (S-BFD) fault detection in a network having BFD or S-BFD sessions.

### DETAILED DESCRIPTION OF THE DISCLOSURE

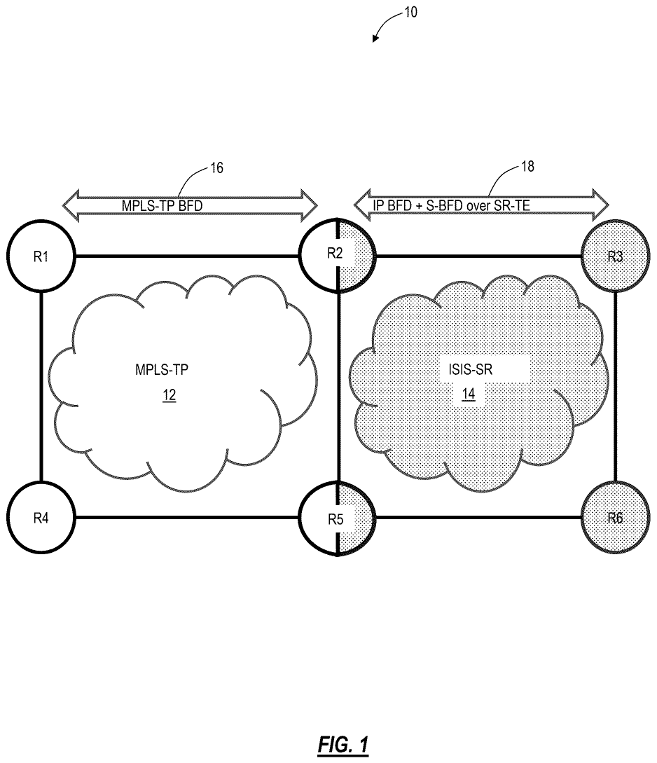

Again, the present disclosure relates to systems and methods for prioritized detection of BFD/S-BFD faults for fault recovery and datapath availability. FIG. 1 illustrates a network 10 split into two distinct transport “domains,” a domain 12 using MPLS-transport protocol (MPLS-TP) and another domain 14 using an intermediate system-intermediate system (IS-IS)-based Segment Routing solution. The network 10 and the domains 12, 14 include various example routers R1-R6. The two domains 12, 14 are interconnected by border routers R2 and R5), which appear half to indicate that they belong to (or at least interconnect) both domains 12, 14.

The MPLS-TP domain 12 includes the routers R1, R2, R4, R5. In an MPLS-TP network, data is forwarded over label-switched paths (LSPs) using the MPLS-TP. This profile emphasizes simpler operational requirements (e.g., static provisioning, operations, administration, and management (OAM) features) suitable for transport networks. FIG. 1 indicates that BFD is running between endpoints in this MPLS-TP domain (MPLS-TP BFD session 16). The IS-IS SR domain 14 includes the routers R2, R3, R5, R6. This part of the network 10 uses IS-IS as its interior gateway protocol (IGP) and takes advantage of SR. Segment routing simplifies MPLS forwarding by encoding path segments (labels) directly in the packet header, eliminating the need for per-LSP state at every hop. Within this domain 14, FIG. 1 notes a BDF/S-BFD session 18 includes both standard IP BFD and “S-BFD over SR-TE” (S-BFD for segment-routing traffic engineering). This indicates that BFD is also used here for path monitoring and fast failure detection, but specialized for segment routing.

The routers R2, R5 are the “edge” or “border” points between the two domains 12, 14. Their split signifies that they are capable of operating in both MPLS-TP and SR domains 12, 14 (or at least can translate traffic and OAM functions between them). Traffic that needs to traverse from the MPLS-TP domain 12 into the SR domain 15 (and vice versa) flows through these border routers R2, R5. The routers R1, R4 lie completely in the MPLS-TP domain 12, and the routers R3, R6 lie completely in the IS-IS-SR domain 14.

The sessions 16, 18 are used to rapidly detect link or forwarding failures. MPLS-TP has its own version of BFD (commonly used for OAM within a transport profile). In the SR domain, IP BFD is still used for general IP links, while S-BFD (Seamless BFD) supports quick end-to-end verification on SR tunnels, referred to here as “S-BFD over SR-TE.” Overall, the network 10 illustrates a scenario where a single network operator (or a multi-domain environment) is running two separate transport technologies—MPLS-TP on one side and Segment Routing via IS-IS on the other—and relies on border routers R2, R5 to bridge the two technologies and ensure continuity of transport services and OAM (such as BFD) across the entire network 10. The network 10 is presented as an example reference topology for illustrating various aspects of the present disclosure.

### Use Case #1—Need for Prioritizing BFD Bootstrapping to Allow Faster Data-Forwarding

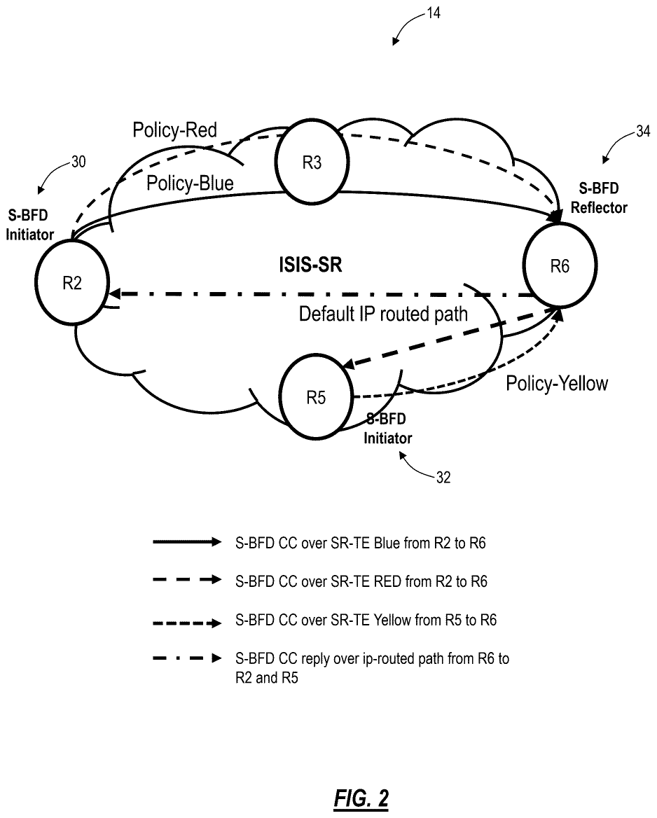

FIG. 2 illustrates the IS-IS SR domain 14 from the network 10 for illustrating a need for prioritizing BFD bootstrapping to allow faster data-forwarding. In the illustrated scenario in FIG. 2, S-BFD initiators 30, 32 are configured on the head-end routers R2, R5 to monitor data paths across multiple Segment Routing (SR) policies—namely Blue, Red, and Yellow—while a S-BFD reflector 34 resides on router R6. According to RFC 9256, “Segment Routing Policy Architecture,” (July 2022), the contents of which are incorporated by reference, an administrator may assign priority values to these SR policies to indicate which traffic flows are most critical. For example, the Red policy might be set to the highest priority by using the lowest numerical value, signaling that any datapath verification and fault detection for Red should take precedence over the other policies.

However, on the router R6, there is no existing mechanism to prioritize S-BFD responses for Red traffic over other simultaneous S-BFD sessions; all incoming S-BFD packets are processed equally. As the number of active SR policies increases, the time required to confirm data-forwarding readiness for Red grows accordingly, diluting its nominal priority advantage. This delay is undesirable, as it prevents the network from achieving swift convergence and rapid data-forwarding enablement for critical traffic flows. Consequently, a mechanism to prioritize BFD/S-BFD bootstrapping-especially for the most critical SR policies-becomes essential for reducing latency, accelerating fault detection, and ensuring high-performance data forwarding where it matters most.

Use case #2—Need for Prioritizing BFD Fault at the Peer

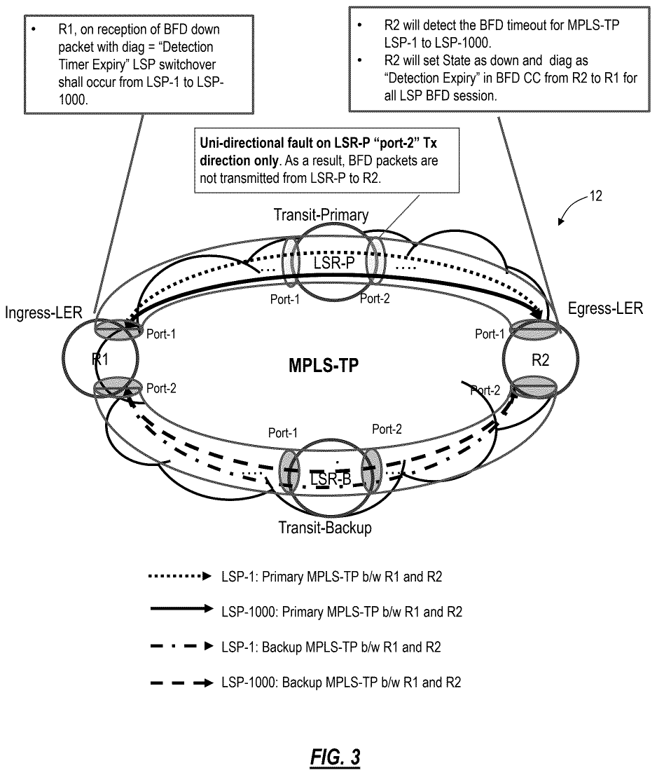

FIG. 3 illustrates the MPLS-TP domain 12 from the network 10 for illustrating a need for prioritizing BFD fault detection/handling. This scenario highlights a unidirectional fault condition where Label Switch Router (LSR)-P is unable to transmit BFD packets on “port-2” toward the router R2, yet it can still receive packets arriving from the router R2 destined for the router R1. In this example MPLS-TP configuration, there are 1,000 LSPs between the routers R1, R2, each monitored by BFD sessions. When the unidirectional fault occurs, the router R2 will detect BFD timeouts for all 1,000 LSPs, generate a “Detection Expiry” diagnostic (diag), and transition each corresponding BFD session to the “down” state. The router R2 then triggers traffic switchover to the backup LSP at an egress Label Edge Router (LER), e.g., the router R2.

However, consider that LSP-1 carries real-time, latency-sensitive data, while the remaining 999 LSPs (LSP-2 to LSP-1000) support less critical traffic. Ideally, the notification of BFD faults for LSP-1 should be prioritized, allowing the router R1 to receive a high-priority fault indication and perform an immediate switchover for that mission-critical flow. In the absence of a prioritization mechanism, all LSPs effectively queue for fault processing in the same way, causing real-time traffic to endure the same delay as best-effort traffic. This can lead to unacceptable service degradation for latency-sensitive applications and undermine service-level objectives (SLOs).

By implementing a priority-based fault notification approach, the router R2 could flag BFD events for LSP-1 ahead of the other 999 LSPs, enabling R1 to execute rapid switchover specifically for the high-priority flow. Such a mechanism supports that critical data can be quickly rerouted onto a stable backup path, limiting or minimizing downtime and maintaining the high service quality expected of MPLS-TP in large-scale deployments.

### Use Case #3—Need for Prioritizing BFD Fault Processing on Local

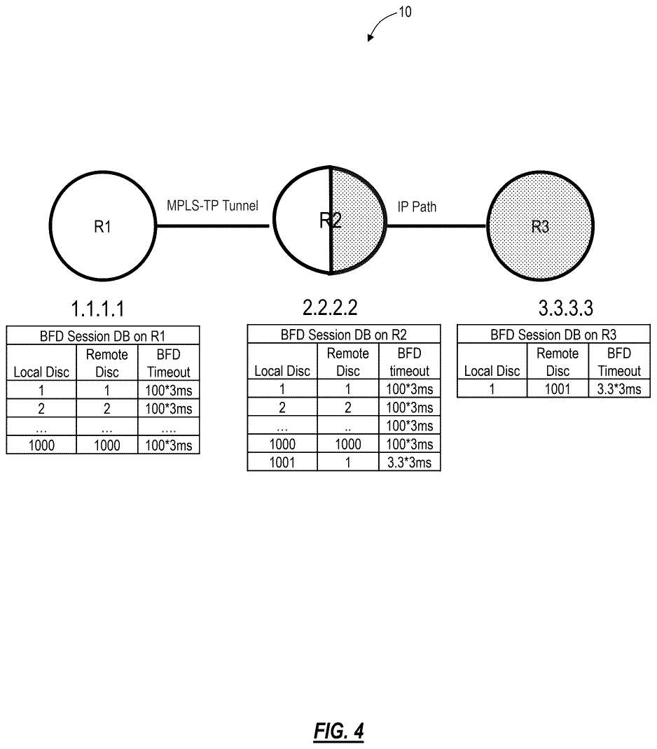

FIG. 4 illustrates the network 10 for illustrating a need for prioritizing BFD fault processing. Again, in this scenario, e.g., there are 1,000 MPLS-TP BFD sessions configured between the routers R1, R2 to monitor the backup paths of MPLS-TP tunnels. Concurrently, an IP single-hop (IP-SH) BFD session is configured between the routers R2, R3 for monitoring the IS-IS adjacency, where any BFD fault triggers Topology Independent-Loop-Free Alternate (TI-LFA) mechanisms to prevent disruptions on the overlay network.

Ideally, local fault processing on the router R2 should prioritize the IP-SH BFD session over the 1,000 MPLS-TP BFD sessions. This supports that, in the event of a dual failure-one affecting routers R1-R2 and another affecting routers R2-R3-R2 rapidly detects and addresses the IP-SH BFD fault before it processes the numerous MPLS-TP BFD fault events. Without such prioritization, the router R2 may queue the high-impact IP-SH BFD session's fault behind those for many or all of the 1,000 MPLS-TP tunnels, incurring unacceptable delays in triggering TI-LFA. This queuing delay is problematic because timely fault detection and remediation for the IS-IS adjacency are crucial to maintaining fast reroute capabilities in the network.

Although this example focuses on MPLS-TP and IP-SH BFD sessions, the underlying issue—needing to prioritize certain BFD sessions over others—applies to all BFD flavors. Absent a clear mechanism to prioritize local fault processing, operators risk prolonged outages for critical services and suboptimal failover times when multiple BFD sessions simultaneously experience faults.

### Proposed Approach

The present disclosure introduces a configurable attribute—referred to as “prioritization”—within a BFD template or BFD profile. By default, this attribute can be disabled, supporting backward compatibility for existing network deployments. Enabling “prioritization” triggers a set of enhancements to both BFD and S-BFD processes, thereby allowing operators to more effectively manage high-priority traffic flows and fault conditions. Specifically, once prioritization is enabled, the system employs newly defined diagnostic (diag) codes for BFD sessions that require faster bootstrapping and fault processing. This approach allows for critical data paths to receive immediate attention, while non-critical sessions continue to be handled under normal conditions.

The present disclosure includes a configuration attribute, prioritized BFD/S-BFD bootstrapping, prioritized fault detection and processing, and new diagnostic codes. Embodiments may include one, some, or all of such features.
(1) Configuration Attribute—A new attribute, “prioritization,” is introduced under the BFD template/profile. Administrators can enable or disable this feature at the session or policy level based on network requirements and service-level objectives (SLOs). When disabled, BFD sessions operate under the existing standards (e.g., RFC 5880) with no distinction between critical and non-critical paths. When enabled, the system applies new diag codes to sessions marked as prioritized, ensuring those sessions receive expedited bootstrapping, fault detection, and recovery handling.
(2) Prioritized BFD/S-BFD Bootstrapping—By applying the prioritization attribute, high-value BFD/S-BFD sessions are established and validated more quickly than sessions carrying lower-priority traffic. This supports rapid path verification and earlier activation of mission-critical services, potentially reducing startup latencies and improving overall service continuity.
(3) Prioritized Fault Detection and Processing-Once a prioritized BFD session is running, any subsequent fault (e.g., unidirectional link failure, neighbor down, path down) is assigned higher precedence in both local and peer fault queues. This mechanism tends to reduce or minimize the time to detect and respond to critical session failures, as opposed to waiting in the same processing queue as non-prioritized sessions.
(4) New Diagnostic Codes—To accommodate prioritized sessions, six new example diag codes extend the existing diag codes defined in RFC 5880. These codes support that both local and remote endpoints can distinguish a prioritized event from standard fault scenarios:

| | |
|---|---|
| 21 | ″Prioritized No-Diag″ |
| 22 | ″Prioritized Control Detection Expiry″ |
| 23 | ″Prioritized Neighbor Signaled Down″ |
| 24 | ″Prioritized Path Down″ |
| 25 | ″Prioritized Concatenated Path Down″ |
| 26 | ″Prioritized Admin Down″ |

By incorporating these new diag codes, the system can detect, propagate, and respond to priority-based faults without disrupting or conflating them with non-prioritized BFD events. This clear delineation offers tangible benefits in large-scale or multi-tenant networks, where numerous BFD sessions may be active simultaneously. Ultimately, the proposed solution empowers network operators to align failure detection and recovery processes more closely with application requirements, supporting that critical services maintain sufficiently high (e.g. the highest possible) availability and performance. It is noted that the new diag codes may function similarly to their existing, non-prioritized counterparts as defined for example in RFC 5880, but pertain to prioritized sessions.

### Proposed Approach Re: Use Case #1—Need for Prioritizing BFD Bootstrapping to Allow Faster Data-Forwarding

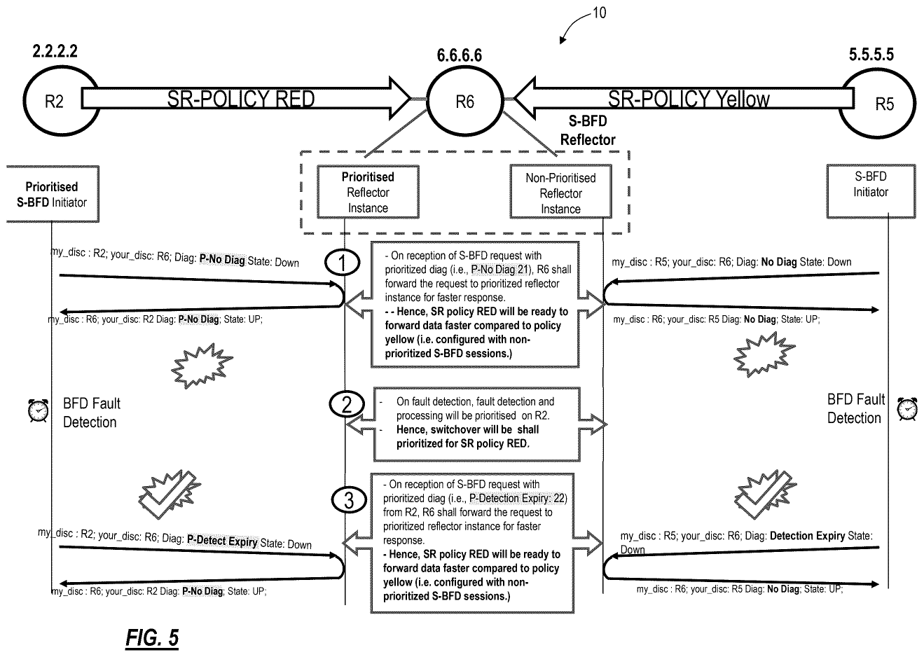

FIG. 5 illustrates the IS-IS SR domain 14 from the network 10, as in FIG. 2, for illustrating the proposed solution for prioritizing BFD bootstrapping to allow faster data-forwarding. The router R2 is the head-end router for the high-priority SR policy (labeled “RED”) and initiates Seamless BFD (S-BFD) probes for it. The router R5 is the head-end router for a lower-priority SR policy (labeled “YELLOW”), also initiating S-BFD probes. The router R6 is the tail-end (reflector) node, which is configured with two S-BFD reflector instances:
(1) A prioritized reflector instance designed to handle BFD sessions marked with a “prioritized” diag code.
(2) A non-prioritized reflector instance for all standard (non-prioritized) BFD sessions.

The router R2's S-BFD session for the RED policy uses newly introduced diag codes (e.g., P-No Diag (21), P-Detect Expiry (22), as defined above), indicating a prioritized session. When the router R2 sends these prioritized S-BFD packets toward the router R6, it signals that the datapath and fault detection for the RED policy should be handled with higher urgency.

### Step-by-Step Flow

(1) Reception of a Prioritized S-BFD Request—Upon receiving an S-BFD request with diag code P-No Diag (21), the router R6 recognizes this code as belonging to a high-priority session. The router R6 forwards the request to the prioritized reflector instance, prompting an immediate response to the router R2. As a result, the SR policy RED is “bootstrapped” more quickly, allowing data to flow faster compared to a non-prioritized policy (such as YELLOW).
(2) Fault Detection and Processing—If a fault occurs (e.g., a potential link issue or detection timer expiry), the router R2 will prioritize the RED policy's fault detection and switchover procedure. This provides that the failover or corrective action for the critical RED policy is taken first, minimizing downtime for high-priority traffic.
(3) Reception of a Prioritized Fault—Indication-When the router R2 detects a more severe fault-indicated by a diag code like P-Detect Expiry (22)—and sends a corresponding S-BFD packet to the router R6, the process again leverages (e.g. R6 again invokes) the prioritized reflector instance. As a result, the SR policy RED's fault-indication traffic is handled swiftly on the router R6's side as well, providing for rapid fault recognition, notification, and subsequent resolution or switchover.
(4) Comparing Prioritized vs. Non-Prioritized Sessions—RED (Prioritized): Uses the newly introduced diag codes (P-No Diag, P-Detect Expiry, etc.), supporting or ensuring accelerated bootstrapping, detection, and recovery. YELLOW (Non-Prioritized): Uses the standard diag codes; its BFD control and fault detection follow normal processing without special priority.
(5) Outcome
(a) Faster Data Forwarding: Because the routers R6, R2 immediately process and respond to high-priority signals (e.g., the RED policy), the network can bring up critical paths sooner and react to faults faster.
(b) Reduced Failover Times: If a fault is detected, switchover is prioritized for the high-value RED traffic, limiting or minimizing impact on certain services, for example those that require strict uptime or low latency.
(c) Separation of Workflows: By splitting traffic into prioritized and non-prioritized reflector instances on the router R6, the high-priority flows do not get delayed by lower-priority sessions that might also be sending BFD requests or fault notifications. In addition, it is noted that, although various examples illustrate two sets of diag codes and two reflector instances, embodiments are not necessarily limited to this configuration-indeed, embodiments may potentially employ two, three or more sets of diag codes, reflector instances, or both, representing a corresponding number of different priority levels.

In essence, FIG. 5 demonstrates how newly introduced diag codes enable a distinct “fast lane” for critical S-BFD sessions. FIG. 5's numbered callouts (1, 2, 3) walk through the steps of receiving prioritized requests, detecting faults, and forwarding fault indications, all within a framework that differentiates high-priority traffic (RED) from normal-priority traffic (YELLOW). This mechanism ensures that mission-critical services receive expedited bootstrapping and fault handling, aligning with strict performance and availability requirements.

### Proposed Approach Re: Use Case #2—Need for Prioritizing BFD Fault at the Peer

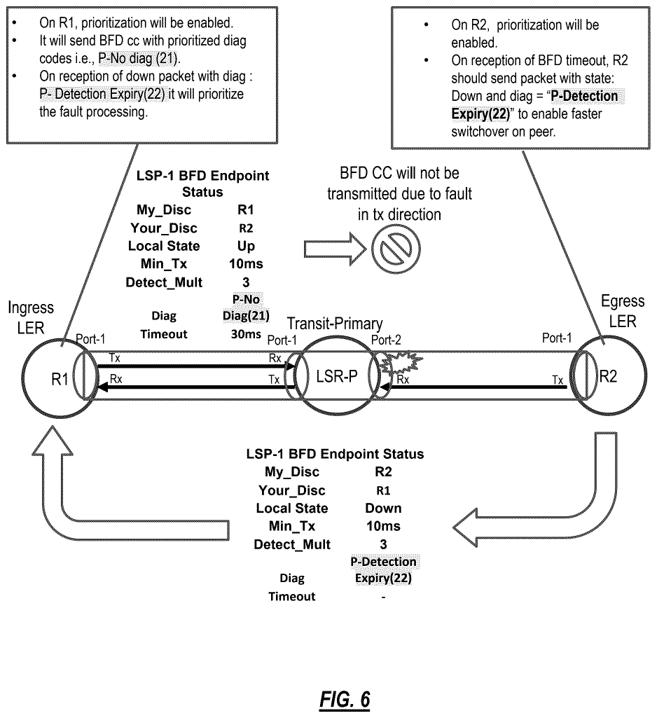

FIG. 6 illustrates the MPLS-TP domain 12 from the network 10, as in FIG. 3, for illustrating the proposed solution for prioritizing BFD faults. FIG. 6 illustrates a unidirectional fault in a Label Switched Path (LSP) connecting the routers R1, R2 through an intermediate node, LSR-P:
(1) Network Setup and Prioritization—the routers R1, R2 each have BFD sessions monitoring an MPLS-TP LSP (labeled LSP-1). The LSP traverses LSR-P, which experiences a unidirectional fault—specifically, it cannot transmit packets toward the router R2, but can still receive them coming from the router R2. Prioritization is enabled on both the routers R1, R2, so they use new diag codes (P-No Diag (21), P-Detection Expiry (22)) to indicate higher-priority handling for this LSP's BFD sessions.
(2) Normal Operation at the route R1—Initially, the router R1's local BFD endpoint is in the “Up” state with diag code P-No Diag (21). “P-No Diag” signals a prioritized but healthy session, allowing any subsequent issues with LSP-1 to be processed more quickly than non-prioritized sessions.
(3) Unidirectional Fault on LSR-P—A fault occurs on LSR-P's transmit path toward the router R2, causing BFD packets from LSR-P to the router R2 to be lost. However, the router R2 can still send BFD packets toward LSR-P (and possibly to the router R1), so the failure is only in one direction.
(4) Detection of the Fault at the router R2—Because the router R2 never receives the BFD packets that should be coming from LSR-P (on behalf of the router R1), the router R2's BFD session times out. Once the session times out, the router R2 transitions its local BFD state to “Down” and sets the diag code to P-Detection Expiry (22)—again indicating prioritized fault detection.
(5) Prioritized Fault Notification from the routers R2, R1—the router R2 sends a BFD “Down” message with P-Detection Expiry (22) back toward the router R1, signifying that it has detected a critical failure on LSP-1. Because the diag code is “prioritized,” it allows local fault processing on the router R2 (and subsequently on the router R1) to be elevated above any other non-prioritized BFD sessions that might also be experiencing faults.
(6) Faster Switchover and Recovery-Upon receiving the “Down” message with P-Detection Expiry (22), the router R1 recognizes that LSP-1 is no longer reliable. Since the router R1 is configured for prioritized processing, it can immediately trigger a switchover to a backup path (if available) for the traffic that was traversing LSP-1. This rapid response can inhibit extended downtime for any high-priority or latency-sensitive traffic on LSP-1.

Prioritized Sessions: the routers R1, R2 both use diag codes (21 for normal “no diagnostic” but prioritized sessions, and 22 for “detection expiry”) that indicate higher urgency to their BFD stacks.

Local and Peer Prioritization: On the transmitting side (the router R2), the fault detection event is moved to the head of the queue due to the prioritized diag code, and the notification sent to the router R1 is also treated with higher priority.

Minimized Outage: By assigning priority to LSP-1, real-time or mission-critical traffic is rerouted faster, reducing potential service disruption.

In summary, this diagram demonstrates how newly introduced, prioritized diag codes in BFD enable rapid detection and communication of faults on critical LSPs. When a unidirectional failure occurs, the router R2 immediately flags the issue with P-Detection Expiry (22), supporting that both local and remote nodes treat the event with heightened priority, thus expediting switchover and minimizing downtime.

### Proposed Approach Re: Use Case #3—Need for Prioritizing BFD Fault Processing on Local

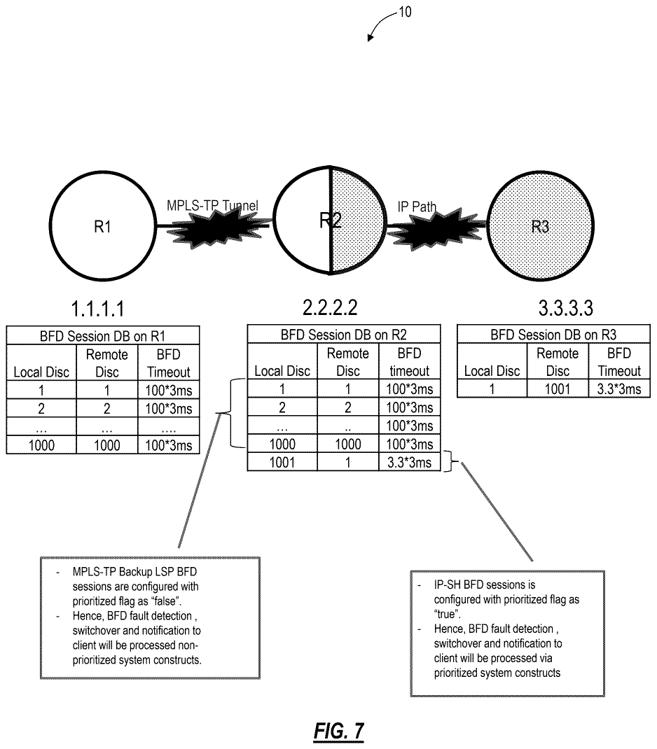

FIG. 7 illustrates the network 10, as in FIG. 4, for illustrating the proposed solution for prioritizing BFD fault processing. FIG. 7 illustrates how prioritizing certain BFD sessions on the local node (the router R2) can expedite fault detection and network convergence when multiple BFD sessions coexist:

Again, between the routers R1, R2, there are 1,000 MPLS-TP LSP BFD sessions established between R1 and R2. These sessions are used to monitor backup paths for MPLS-TP tunnels. Between the routers R2, R3, there is an IP single-hop (IP-SH) BFD session for monitoring an IS-IS adjacency. Any fault on this session triggers Topology Independent-Loop-Free Alternate (TI-LFA) to protect overlay traffic. FIG. 7 illustrates potential failures both on the MPLS-TP tunnel (between the routers R1, R2) and on the IP path (between the routers R2, R3). A key challenge is to ensure that, if faults occur simultaneously, the more critical IP-SH BFD session (between the routers R2, R3) is processed first, rather than being queued behind the 1,000 MPLS-TP sessions.

Each router maintains a BFD session database indicating local discriminator (“disc”), remote discriminator, BFD timeout, and whether the session is flagged as “prioritized” or not. The diagram highlights three databases:
(1) Router R1's Database-Local Disc ranges from 1 to 1,000, each matching Remote Disc from 1 to 1,000 on R2. Each session has a timeout (e.g., 100*3 ms in this example). These sessions are not prioritized; hence, if they fail, fault handling follows the normal, non-prioritized processing queue.
(2) Router R2's Database-Reflects the same 1,000 MPLS-TP BFD sessions with matching local/remote discriminators and timeouts (100*3 ms). A “Prioritized” column shows False for all 1,000 MPLS-TP sessions. In contrast, there is one IP-SH BFD session (for the router R2, R3 adjacency) with a local disc of 1001 and remote disc of 1. This session has a tighter or otherwise distinct BFD timeout (e.g., 3.3*3 ms) and a “Prioritized” value of True.
(3) Router R3's Database-Mirrors the IP-SH BFD session with local disc=1 and remote disc=1001. It is also configured with a relatively short or more aggressive BFD timeout (e.g., 3.3*3 ms). This session is recognized as prioritized on R3's side as well.

### Why Prioritization Matters

MPLS-TP Backup LSP Sessions (Non-Prioritized)—With 1,000 sessions on the routers R1, R2, if a fault occurs, each session that times out will require processing time to declare “down” and potentially trigger backup procedures. Because they are flagged as “False” (non-prioritized), they do not jump ahead in any fault-handling queue.

IP-SH Session (Prioritized)—The single BFD session between the routers R2, R3 is marked “True” for prioritization. In a dual-failure scenario (one affecting the routers R1, R2 and another affecting the routers R2, R3), the router R2 immediately processes the IP-SH session's fault before tackling the 1,000 MPLS-TP session timeouts. This provides that the IS-IS adjacency fault is resolved (or TI-LFA is invoked) without waiting behind hundreds or thousands of MPLS-TP BFD events.

For an operational flow in FIG. 7:
(1) Fault Occurs on MPLS-TP and/or IP Path—A failure might disable traffic on the routers R1, R2 MPLS-TP tunnel or the routers R2, R3 IP path. Both sets of BFD sessions (MPLS-TP and IP-SH) will start detecting the fault based on their configured timeouts.
(2) BFD Timeout and State Changes—The 1,000 MPLS-TP sessions on the routers R1, R2 begin to enter the “Down” state after their detection timers expire. The IP-SH session on routers R2, R3 also transitions to “Down” if its adjacency fails.
(3) Prioritized vs. Non-Prioritized Processing—Because the IP-SH session is flagged as “True” for prioritization, the local BFD engine on the router R2 handles it first, notifying any upper-layer processes (e.g., IS-IS for TI-LFA) to reroute or protect traffic. Meanwhile, the 1,000 MPLS-TP sessions, each flagged as “False,” proceed through fault detection and notification under the normal, non-prioritized queue.

Faster Recovery for Critical Services: Any service relying on the routers R2, R3 adjacency (e.g., real-time applications) benefits from more immediate convergence.

Limited or minimal Impact on Lower-Priority Tunnels: The MPLS-TP backup LSPs eventually fail over, but only after the high-priority IP-SH session is taken care of—providing that critical network operations do not experience undue delay.

### Notable Benefits Include

(1) Scalability: Even as the number of MPLS-TP LSPs grows (e.g., beyond 1,000), the IP-SH session retains its elevated status, providing that time-critical tasks get prompt attention.
(2) Service Quality: Real-time or high-value traffic is restored swiftly, reducing or preventing extended downtime or breaches of service-level objectives.
(3) Clear Policy Control: Operators can selectively mark which sessions are “prioritized,” allowing for granular control that aligns with business or operational requirements.

In summary, FIG. 7 underscores how introducing a “prioritized” flag into BFD sessions enables local fault handling to focus on the most critical paths first. In the face of simultaneous faults, the router R2 provides that its IP-SH session with the router R3—vital for fast reroute (TI-LFA)—is processed ahead of the numerous MPLS-TP backup LSP sessions to maintain good or optimal network performance and reliability.

### Router

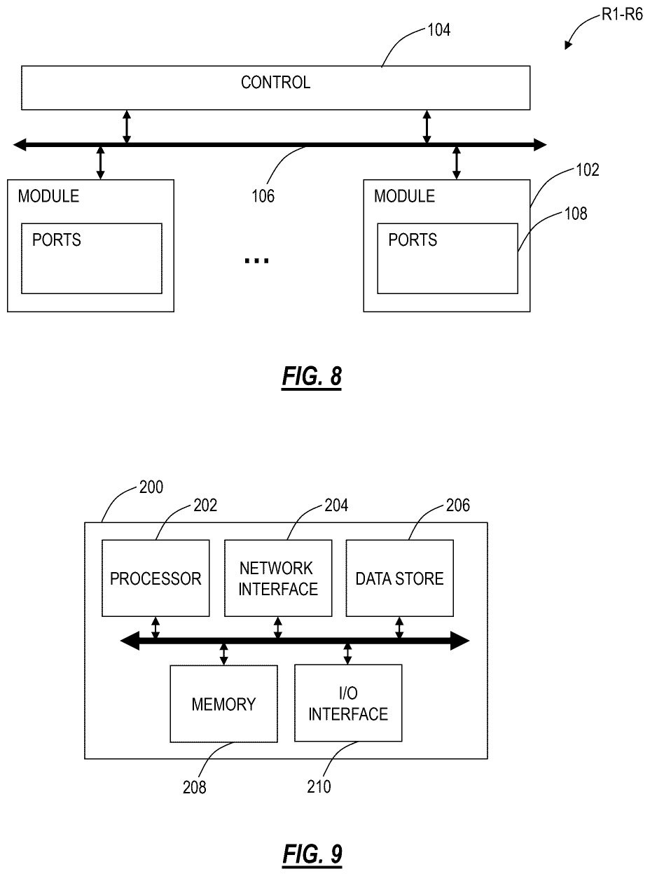

FIG. 8 illustrates a block diagram of a router R1-R6, depicted in a simplified functional format. It is important to note that a more practical design of this router would likely include additional components and processing logic to accommodate standard operating features, which are not detailed here. The router R1-R6 may represent any network element operable in a network using optical and packet protocols, and includes various interconnected modules, such as modules 102 and 104, via an interface 106. These modules, also known as blades or line cards, are typically mounted on the chassis of a data switching device. Each module can house numerous electronic or optical devices on a circuit board, complete with various interconnects, including interfaces to the chassis itself.

Specifically, the diagram illustrates two types of modules: line modules 102, which feature multiple Ethernet ports for external connections, and a control module 104. The line modules facilitate data traffic switching between ports via a switching fabric, integrated across the modules, potentially centralized in a separate unit or module, as well as a combination. This switching fabric includes hardware, software, and firmware that routes incoming data to the appropriate port. The control module 104 is equipped with a microprocessor, memory, software, and a network interface to manage operations such as configuration and monitoring of the router R1-R6. It may also communicate with external network management systems or databases that handle provisioning and operational data.

Lastly, while FIG. 8 provides a basic view, those skilled in the art will understand that the router R1-R6 could include additional components or be configured differently, such as in a distributed arrangement or as an integrated, rack-mounted unit (often referred to as a “pizza-box” configuration). This depiction in FIG. 8 is intended to convey functional aspects, with actual hardware implementations varying widely.

FIG. 9 illustrates a block diagram of an example processing device 200. The processing device 200 may be integrated within the router R1-R6 or function as a standalone unit connected to the router R1-R6. It may also be known as an apparatus, a control module, shelf controller, shelf processor, or system controller. The core of the processing device 200 is a processing unit 202, a hardware unit that runs software instructions. The processing unit 202 could be one or more custom or commercially available processors, i.e., one or more processors. During operation, the processing unit 202 executes software from memory, manages data communication with the memory, and controls the processing device 200 operations based on the software.

The processing device 200 also features several components connected to the processing unit 202: a network interface 204, a data store 206, memory 208, and an I/O interface 210. The network interface 204, possibly an Ethernet device, allows the processing device 200 to communicate over a data network and includes necessary connections for address, control, and data communication. The data store 206 stores various types of data such as telemetry data, operations, administration, maintenance, and provisioning (OAM&P) data, etc., and may include both volatile (e.g., RAM) and nonvolatile (e.g., ROM, hard drives) memory elements. Similarly, the memory 208 includes volatile and nonvolatile storage media, potentially employing a distributed architecture where components are located remotely but accessible by the processing unit 202. The I/O interface facilitates communication between processing device 200 and external devices.

### Method

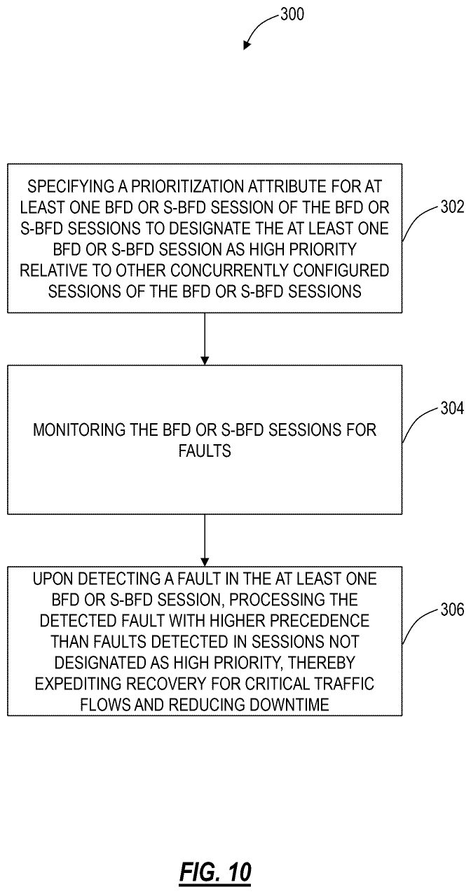

FIG. 10 illustrates a flowchart of a process 300 for performing Bidirectional Forwarding Detection (BFD) or Seamless BFD (S-BFD) fault detection in a network having BFD or S-BFD sessions. The process can be implemented to prioritize the detection/handling of certain faults over others. The process 300 contemplates implementation as a method with steps, via an apparatus, processing device, circuitry, or a router configured to implement the steps, and as a non-transitory computer-readable medium storing instructions that, when executed, cause circuitry to perform the steps.

The steps include specifying a prioritization attribute for at least one BFD or S-BFD session of the BFD or S-BFD sessions to designate the at least one BFD or S-BFD session as high priority relative to other concurrently configured sessions of the BFD or S-BFD sessions (step 302); monitoring the BFD or S-BFD sessions for faults (step 304); and, upon detecting a fault in the at least one BFD or S-BFD session, processing the detected fault with higher precedence than faults detected in sessions not designated as high priority, thereby expediting recovery for critical traffic flows and reducing downtime (step 306).

The prioritization attribute is a configurable parameter in a BFD or S-BFD session template or profile that, when enabled, designates a session as high priority for expedited bootstrapping and fault handling, and when disabled, reverts to standard BFD or S-BFD processing maintaining backward compatibility. The process 300 can further include assigning prioritized diagnostic (diag) codes, distinct from standard diag codes, to indicate high-priority sessions and enable accelerated handling of fault notifications. The process 300 can further include forwarding a prioritized diag code to a remote peer, causing the remote peer to elevate handling of the associated fault relative to other non-prioritized sessions.

The process 300 can further include maintaining two or more reflector instances for S-BFD at a tail-end node, wherein a first reflector instance handles BFD or S-BFD sessions marked with a prioritized diag code and a second reflector instance handles non-prioritized sessions. The process 300 can further include enabling prioritized bootstrapping for the at least one BFD or S-BFD session, causing any path validation or initial session setup for the at least one BFD or S-BFD session to be performed with higher urgency relative to non-prioritized sessions.

Local fault processing on a node can prioritize detection and notification of high-priority sessions over a plurality of concurrent non-prioritized sessions, thereby reducing queuing delays when multiple faults occur simultaneously. Upon detecting a unidirectional link failure for a high-priority session, a fault notification is escalated to trigger a faster switchover to a backup path for latency-sensitive or mission-critical traffic. The process 300 can further include generating a fast reroute trigger when a prioritized diag code indicates a link or path failure, thereby reducing downtime or ensuring minimal downtime for critical data flows. The process 300 can further include transmitting control packets with a prioritized diag code to both local and remote network devices, each device performing a higher-precedence state transition for the affected session to maintain stringent service-level objectives for critical traffic.

### Processing Circuitry and Non-Transitory Computer-Readable Mediums

Those skilled in the art will recognize that the various embodiments may include processing circuitry of various types. The processing circuitry might include, but are not limited to, general-purpose microprocessors; central processing units (CPUs); digital signal processors (DSPs); specialized processors such as network processors (NPs) or network processing units (NPUs), graphical processing units (GPUs); field programmable gate arrays (FPGAs); programmable logic device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more application-specific integrated circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, read-only memory (ROM), programmable read-only memory (PROM), erasable programmable read-only memory (EPROM), electrically erasable programmable read-only memory (EEPROM), flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### CONCLUSION

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method for performing Bidirectional Forwarding Detection (BFD) or Seamless BFD (S-BFD) fault detection in a network having BFD or S-BFD sessions, the method comprising steps of:
specifying a prioritization attribute for at least one BFD or S-BFD session of the BFD or S-BFD sessions to designate the at least one BFD or S-BFD session as high priority relative to other concurrently configured sessions of the BFD or S-BFD sessions;
monitoring the BFD or S-BFD sessions for faults; and
upon detecting a fault in the at least one BFD or S-BFD session, processing the detected fault with higher precedence than faults detected in sessions not designated as high priority.

2. The method of claim 1, wherein the prioritization attribute is a configurable parameter in a BFD or S-BFD session template or profile that, when enabled, designates a session as high priority for expedited bootstrapping and fault handling, and when disabled, reverts to standard BFD or S-BFD processing maintaining backward compatibility.

3. The method of claim 1, wherein the steps further include
assigning prioritized diagnostic (diag) codes, distinct from standard diag codes, to indicate high-priority sessions and enable accelerated handling of fault notifications.

4. The method of claim 1, wherein the steps further include
forwarding a prioritized diag code to a remote peer, causing the remote peer to elevate handling of the associated fault relative to other non-prioritized sessions.

5. The method of claim 1, wherein the steps further include
maintaining two or more reflector instances for S-BFD at a tail-end node, wherein a first reflector instance handles BFD or S-BFD sessions marked with a prioritized diag code and a second reflector instance handles non-prioritized sessions.

6. The method of claim 1, wherein the steps further include
enabling prioritized bootstrapping for the at least one BFD or S-BFD session, causing any path validation or initial session setup for the at least one BFD or S-BFD session to be performed with higher urgency relative to non-prioritized sessions.

7. The method of claim 1, wherein local fault processing on a node prioritizes detection and notification of high-priority sessions over a plurality of concurrent non-prioritized sessions, thereby reducing queuing delays when multiple faults occur simultaneously.

8. The method of claim 1, wherein upon detecting a unidirectional link failure for a high-priority session, a fault notification is escalated to trigger a faster switchover to a backup path for latency-sensitive or mission-critical traffic.

9. The method of claim 1, wherein the steps further include
generating a fast reroute trigger when a prioritized diag code indicates a link or path failure, thereby reducing downtime for critical data flows.

10. The method of claim 1, wherein the steps further include
transmitting control packets with a prioritized diag code to network devices, each device performing a higher-precedence state transition for the affected session to maintain stringent service-level objectives for critical traffic.

11. A router configured to perform Bidirectional Forwarding Detection (BFD) or Seamless BFD (S-BFD) fault detection in a network having BFD or S-BFD sessions, the router comprising circuitry configured to:
specify a prioritization attribute for at least one BFD or S-BFD session of the BFD or S-BFD sessions to designate the at least one BFD or S-BFD session as high priority relative to other concurrently configured sessions of the BFD or S-BFD sessions,
monitor the BFD or S-BFD sessions for faults, and
upon detecting a fault in the at least one BFD or S-BFD session, process the detected fault with higher precedence than faults detected in sessions not designated as high priority.

12. The router of claim 11, wherein the prioritization attribute is a configurable parameter in a BFD or S-BFD session template or profile that, when enabled, designates a session as high priority for expedited bootstrapping and fault handling, and when disabled, reverts to standard BFD or S-BFD processing maintaining backward compatibility.

13. The router of claim 11, wherein the circuitry is further configured to assign prioritized diagnostic (diag) codes, distinct from standard diag codes, to indicate high-priority sessions and enable accelerated handling of fault notifications.

14. The router of claim 11, wherein the circuitry is further configured to
forward a prioritized diag code to a remote peer, causing the remote peer to elevate handling of the associated fault relative to other non-prioritized sessions.

15. The router of claim 11, wherein the circuitry is further configured to
maintain two or more reflector instances for S-BFD at a tail-end node, wherein a first reflector instance handles BFD or S-BFD sessions marked with a prioritized diag code and a second reflector instance handles non-prioritized sessions.

16. The router of claim 11, wherein the circuitry is further configured to
enable prioritized bootstrapping for the at least one BFD or S-BFD session, causing any path validation or initial session setup for the at least one BFD or S-BFD session to be performed with higher urgency relative to non-prioritized sessions.

17. A non-transitory computer-readable medium storing instructions for performing Bidirectional Forwarding Detection (BFD) or Seamless BFD (S-BFD) fault detection in a network having BFD or S-BFD sessions, the instructions, when executed, cause circuitry to perform steps of:
specifying a prioritization attribute for at least one BFD or S-BFD session of the BFD or S-BFD sessions to designate the at least one BFD or S-BFD session as high priority relative to other concurrently configured sessions of the BFD or S-BFD sessions;
monitoring the BFD or S-BFD sessions for faults; and
upon detecting a fault in the at least one BFD or S-BFD session, processing the detected fault with higher precedence than faults detected in sessions not designated as high priority.

18. The non-transitory computer-readable medium of claim 17, wherein the prioritization attribute is a configurable parameter in a BFD or S-BFD session template or profile that, when enabled, designates a session as high priority for expedited bootstrapping and fault handling, and when disabled, reverts to standard BFD or S-BFD processing maintaining backward compatibility.

19. The non-transitory computer-readable medium of claim 17, wherein the steps further include
assigning prioritized diagnostic (diag) codes, distinct from standard diag codes, to indicate high-priority sessions and enable accelerated handling of fault notifications.

20. The non-transitory computer-readable medium of claim 17, wherein the processing the detected fault with higher precedence includes forwarding a prioritized diag code to a remote peer, causing the remote peer to elevate handling of the associated fault relative to other non-prioritized sessions.
